(19) United States
(12) Patent Application Publication
(10) Pub. No.: US 2010/0174215 A1
(43) Pub. Date: Jul. 8, 2010

(54) Rotary Apparatus

(76) Inventor: Robert Israels, Grand Rapids, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/349,705

(22) Filed: Jan. 7, 2009

(51) Int. Cl. A61H 1/00

(52) U.S. Cl. 601/24; 601/26

(57) ABSTRACT

A rotary apparatus is provided that includes a base having a top surface. The base is configured to have a mount movably connected to the top surface of the base. A drive mechanism is mounted adjacent to the top surface of the base and rotatably connected to the mount such that the mount moves along the top surface of the base. A platform is configured to receive a user of the rotary apparatus, wherein the platform is connected to the mount and rotatably connected to the drive mechanism such that the platform rotates with respect to the base at an axis point.

### TECHNICAL FIELD

The present invention generally relates to a rotary apparatus, and more particularly, to a rotator apparatus and a method for treatment of diseases associated with poor circulation.

### BACKGROUND OF THE INVENTION

Generally, people suffering from peripheral vascular disease or poor circulation in general, have a gradual thickening and hardening in the walls of the arteries, the blood vessels that bring blood to the extremities from the heart, causing a numbness or tingling in the extremities, changes in the color of skin, changes in skin temperature, skin breakdowns and sores which do not heal as well as they should, claudication (a dull cramping pain in the extremities) and other symptoms which are associated with a lack of blood flow to the extremities. The most common cause of poor circulation, or peripheral vascular disease, is the build up of plaque on the inner walls of arteries. As the plaque builds up along the inner walls of the arteries, there is less room for blood to flow such that muscles and other tissues in the extremities are starved of the vital nutrients normally received through the circulatory system. This hardening of the arteries is called atherosclerosis, and as these plaque deposits build up over time one's chances increase for having a heart attack or stroke.

Currently, patients suffering from peripheral vascular disease are treated by a doctor or vascular surgeon by monitoring blood glucose levels (particularly if diabetes is present), monitoring blood pressure, exercise, quitting smoking, and monitoring cholesterol levels. Drugs can be used to prevent blood clotting such as aspirin, and other medicines can be used to lower cholesterol and control symptoms. In more severe cases, angioplasty or bypass surgery may be used to open narrowed arteries or to re-route blood flow from areas of blockage. In even more severe cases, peripheral vascular disease can cause tissues in the extremities to die because they do not get enough oxygen as a result of the poor blood flow. In these severe cases it is possible that part or all of the extremity must be removed to ensure the survival of the patient.

### SUMMARY OF THE INVENTION

According to one aspect of the present invention, a rotary apparatus is provided that includes a base having a top surface. The base is configured to have a mount movably connected to the top surface of the base. A drive mechanism is mounted adjacent to the top surface of the base and rotatably connected to the mount such that the mount moves along the top surface of the base. A platform is configured to receive a user of the rotary apparatus, wherein the platform is connected to the mount and rotatably connected to the drive mechanism such that the platform rotates with respect to the base at an axis point.

According to another aspect of the present invention, a rotary apparatus is provided that includes a base having a top surface. A mount is movably connected to the top surface of the base and an electric motor adjacent to the top surface of the base and is rotatably connected to the mount such that the mount moves along the top surface of the base. A chair is configured to receive a user of the rotary apparatus, wherein the chair is connected to the mount and rotably connected to the electric motor. The chair rotates with respect to the base at an axis point that extends through a neck region of the user at a therapeutically effective amount of revolutions per minute (rpms) such that the blood of the user is urged from the access point to at least one extremity of the user.

According to yet another aspect of the present invention, a method of treating poor circulation is provided that includes the steps of providing a rotary apparatus for use by a patient and controlling the rotational speed of the rotary apparatus to further provide a therapeutically effective amount of centripetal force to the patient with sufficient energy and sufficient time to promote blood flow to the extremities.

These and other features, advantages, and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a perspective view of a rotary apparatus embodying the present invention;

FIG. 2 is a fragmentary elevational view of the front of the rotary apparatus;

FIG. 3 is a fragmentary elevational view of the rear of the rotary apparatus;

FIG. 4 is a fragmentary perspective view of a mount of the rotary apparatus;

FIG. 5 is a fragmentary side elevational view of the rotary apparatus;

FIG. 5A-5C are fragmentary side elevational views of the rotary apparatus;

FIG. 6 is a top plan view of the rotary apparatus; and

FIG. 7 is a top plan view of the rotary apparatus.

### DESCRIPTION OF PREFERRED EMBODIMENTS

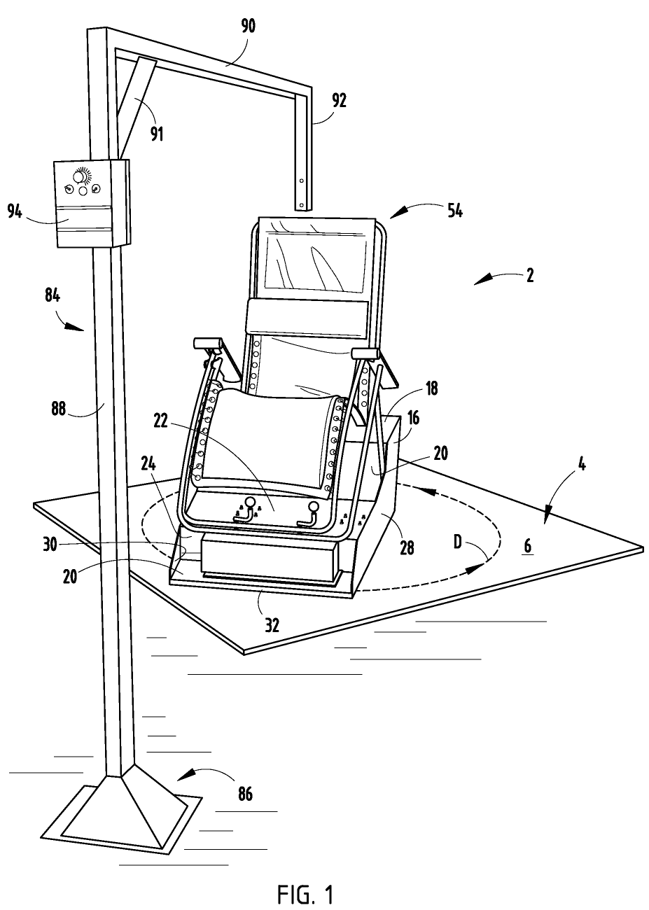

For the purposes of description herein, the terms “upper,” “lower,” “right,” “left,” “rear,” “front,” “vertical,” “horizontal,” and derivates thereof shall relate to the invention as orientated in FIG. 1. However, it is to be understood that the invention may assume various alternative orientations, except where expressly specified to the contrary. It is also to be understood that the specific devices and processes illustrated in the attached drawings, and described in the following specification, are simply exemplary embodiments. Hence, specific dimensions and other physical characteristics relating to the embodiments disclosed herein are not to be construed as limiting, unless expressly stated otherwise.

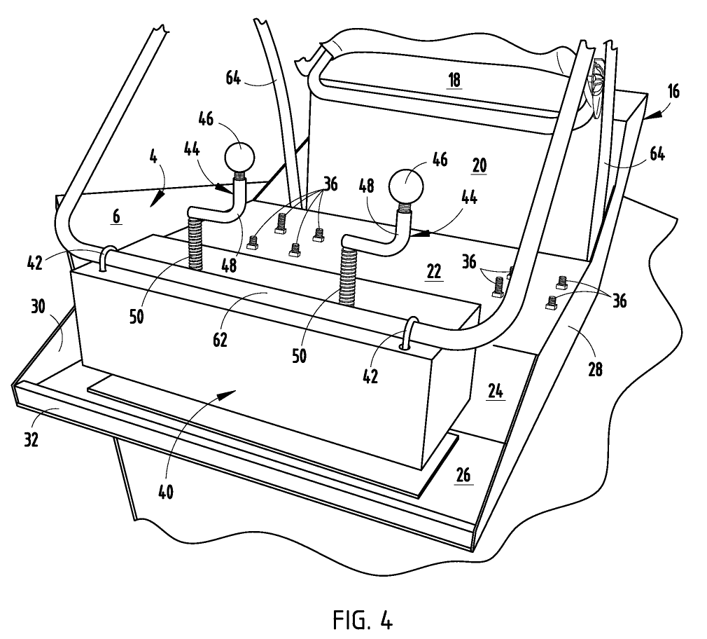

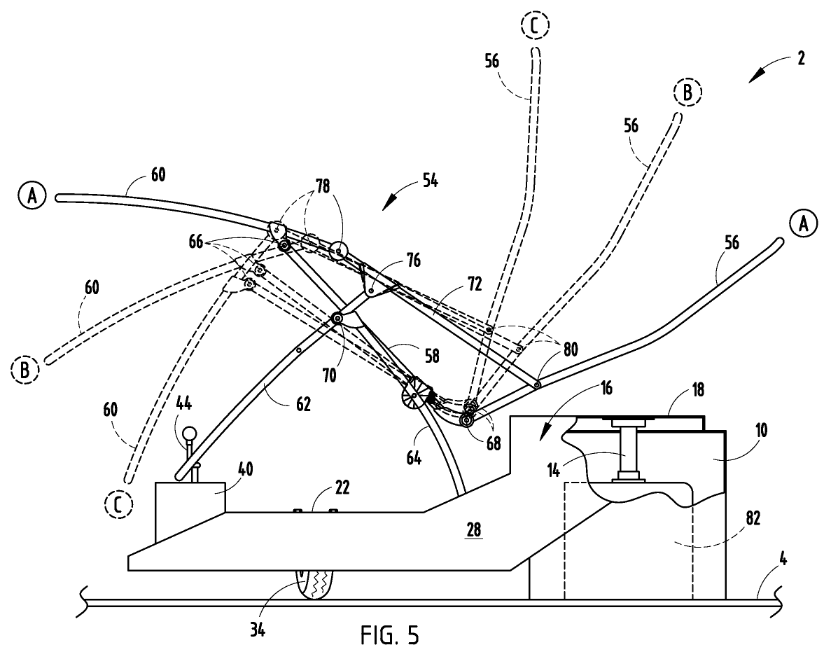

The reference numeral 2 (FIG. 1) generally designates a rotary apparatus for use in treatment of diseases related to poor circulation, the rotary apparatus 2 including a base 4 having a top surface 6, wherein the base 4 is configured to be abuttingly supported on a floor surface. A drive mechanism 8 is mounted adjacent to the top surface 6 of the base 4 at the center of the top surface 6 of the base 4 (FIG. 3). As shown in FIG. 3, the drive mechanism 8 includes a drive mechanism housing 10, which has a generally cube shaped configuration with an aperture 12 generally disposed on the top of the drive mechanism 10 through which a drive shaft 14 is generally disposed. The drive shaft 14 is rotatably connected to a mount 16 (FIGS. 1, 2, and 3). As shown in FIGS. 1 and 4, the mount 16 has a multi-tier configuration having a first tier 18, a vertical section 20, a second tier 22 connected to the first tier 18 by the vertical section 20, a vertical section 24, and a third tier 26 connected to the second tier 22 by the vertical section 24. The mount 16 further comprises sidewalls 28 and 30, which are disposed in a generally parallel laterally spaced apart relationship which generally follow the contours of tiers 18, 22, and 26, as well as vertical sections 20 and 24. The mount 16 further comprises a bar 32 which connects side walls 28 and 30 at the front of the mount 16.

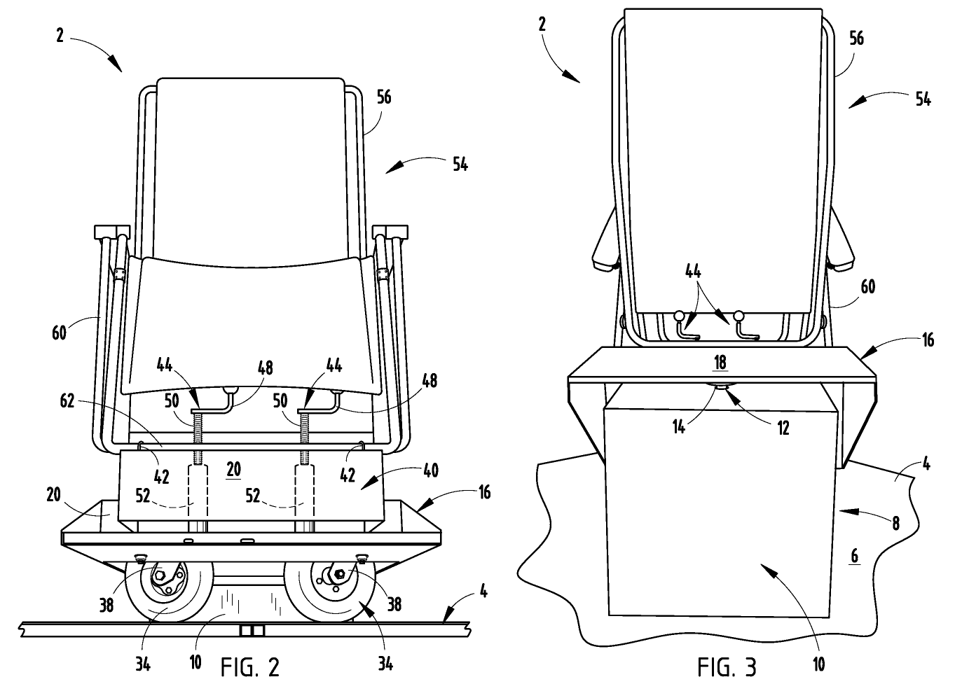

As shown in FIGS. 2 and 4, multi-directional wheel assemblies 34 are mounted to the mount 16 with mounting screws 36 which extend through planar sections (not shown) of wheel mounting assemblies 38 and further through the second tier 22 of the mount 16.

As shown in FIGS. 1, 2, and 4, the mount 16 further comprises a mounting block 40 generally disposed on the third tier 26 of the mount 16. The mounting block 40 further comprises U-shaped bracket assemblies 42 for connection of a furniture item to the mounting block 40 as described below. As shown in FIGS. 2 and 4, the mounting block 40 further comprises S-shaped adjustment assemblies 44 having handle ends 46, curve body portions 48, and threaded ends 50. As shown in FIG. 2, the threaded ends 50 thread into housings 52 disposed underneath the mounting block 40, the housing 52 matingly threads with the threaded ends 50 of the S-shaped adjustment assemblies 44 and adjusts the vertical height of the mounting block 40 upon rotation of the handle ends 46 of the S-shaped adjustment assemblies 44.

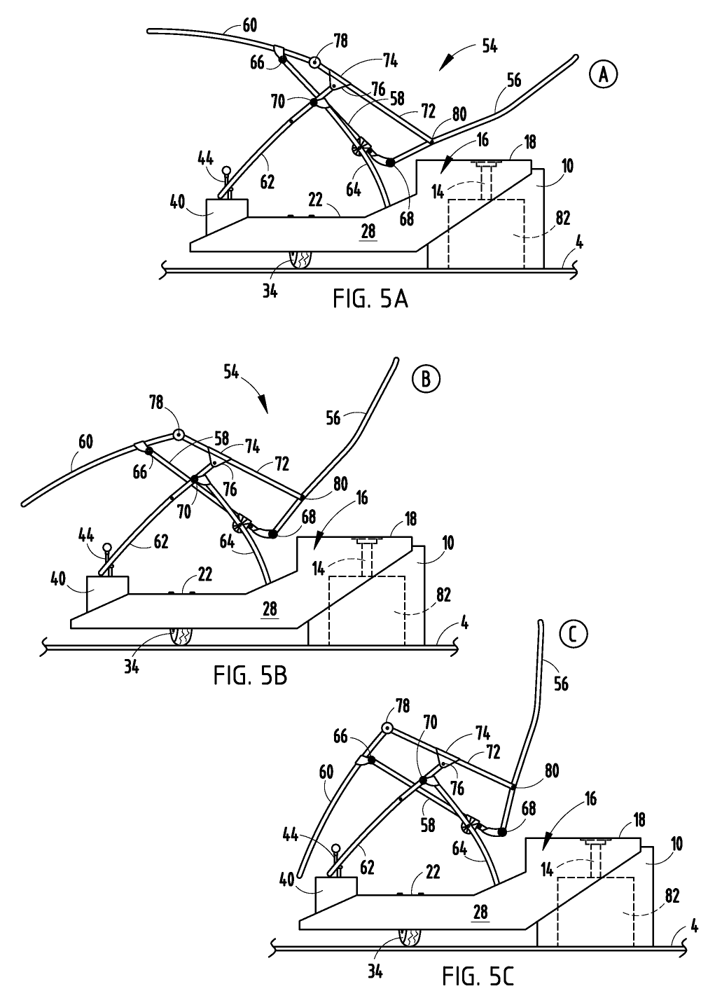

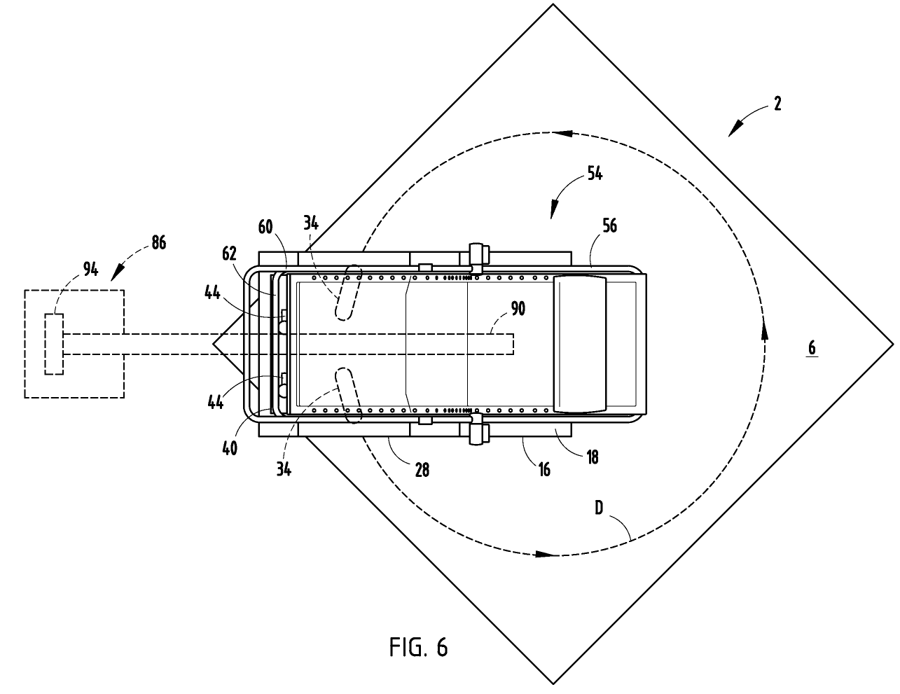

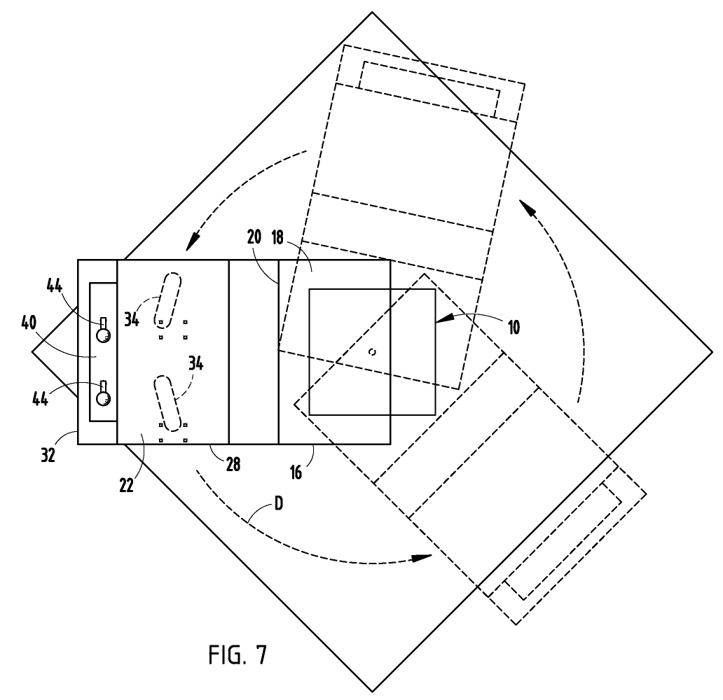

As shown in FIGS. 1 and 5A-5C, the rotary apparatus 2 further comprises a chair assembly 54 mounted to the mount 16. In the embodiment shown in FIGS. 5A-5C, the chair assembly 54 comprises a back section 56, a seat section 58, and a leg support section 60. As shown in FIGS. 5A-5C, the chair assembly 54 has U-shaped leg members 62,64 which connect the chair assembly 54 to the mount 16. The front leg assembly 62 connects to the mounting block 40 by bracket assemblies 42. Thus, the front leg assemblies 62 are adjustable vertically as mounted to the mounting block 40 when the mounting block 40 is adjusted by the S-shape adjustment assemblies 44. The rear leg assemblies 64 are connected to the second tier 22 of the mount 16.

As shown in the embodiment in FIGS. 5A-5C, the chair assembly 54 is an adjustable chair assembly. Pivot point 66 is located between the leg support section 60 and the seat section 58 of the chair assembly 54 and pivot point 68 is located between the seat section 58 and the back section 56 of the chair assembly 54. Pivot point 70 is located at the intersection of the front end rear leg assemblies 62,64. Front leg assembly 62 further connects to an arm rest 72 with the arm rest bracket 74 having a pivot point 76 for direct connection to the front leg assembly 62. Pivot point 78 is disposed between the arm rest 72 and the leg support section 60 of the chair assembly 54, as shown in FIGS. 5A-5C. Pivot point 80 is located between the arm rest 72 and the back section of the chair assembly 54.

As shown in FIGS. 5 and 5A-5C, the chair assembly 54 can be in a variety of positions. In the embodiment shown in FIG. 5, positions A, B, and C are shown. In the embodiment shown in FIG. 5A, position A is shown. In the embodiment shown in FIG. 5B, position B is shown. In the embodiment shown in FIG. 5C, position C is shown.

As shown in FIGS. 5 and 5A-5C, the drive mechanism 8 comprises the drive mechanism housing 10 which contains a drive motor 82. The drive motor 82 is connected to the drive shaft 14 which is further connected to the mount 16 at the first tier 18. In operation, the drive motor 82 rotates the drive shaft 14 which then rotates the mount 16, such that the wheel assemblies 34 follow the dashed line of FIG. 1 in the direction D. The drive motor 82 is of sufficient power to rotate the rotary apparatus 2 with sufficient centripetal force to increase blood flow to the extremities of the user when they are seated in the chair assembly 54. In operation, the rotary apparatus rotates at a speed in the range of 5 to 120 rpms.

In yet another embodiment of the present invention, as shown in FIG. 1, an L-shaped control frame 84 has a base 86 which supports the control frame 84, and a vertical section 88, a cross section 90 attached to the vertical section 88, a support member 91 which supports the cross section 90 from the vertical section 88, and a downward vertical section 92, which extends down within reach of the user of the rotary apparatus 2. The control frame 84 has a systems control 94 generally disposed on the vertical section 88. The systems control 94 houses controls for the speed, rpms, G-force, and timing control of the apparatus 2. The downward vertical section 92 of the control frame 84 has a kill switch (not shown) disposed on its lower most portion, which is in reach of the user of the rotary apparatus 2. Thus, in operation, the user can terminate the rotary session at any point by hitting the kill switch on the downward vertical section 92 of the control frame 84.

In another embodiment of the present invention, the systems control 94 is an integrated unit disposed on the arm rest 72 of the chair assembly 54. Thus, in this embodiment of the present invention, the user can control the speed and duration of the session by the systems control 94 when disposed and integrated into the arm rest 72. In this embodiment in the present invention, a control frame 84 is not necessary.

In another embodiment of the present invention, the user is hooked up to a monitor to measure blood pressure and heart rate (not shown) and the data collected by this monitor can then be analyzed by a separate computer system (not shown) to analyze the progress of the user of the apparatus 2.

The rotary apparatus 2 of the present invention is designed to combat the symptoms of circulatory disorders. These circulatory disorders include, but are not limited to, reflux sympathetic dystrophy (RSD), neuropathy, peripheral vascular disease (or peripheral arterial disease), intermittent claudation, atherosclerosis, venous arterial insufficiency, and cyanosis. Again, the present invention is designed to treat all diseases brought upon by poor circulation and the above list is meant to be exemplary only.

The above description is considered that of preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims, as interpreted according to the principles of patent law, including the doctrine of equivalents.

1. An apparatus comprising:
a base comprising a top surface;
a mount moveably connected to said top surface of said base;
a drive mechanism adjacent to said top surface said base, and rotatably connected to said mount, such that said mount moves along said top surface of said base; and
a platform configured to receive a user of the apparatus, said platform connected to said mount and rotatably connected to said drive mechanism, wherein said platform rotates with respect to said base at an axis that extends through a neck region of said user.

2. The apparatus of claim 1, wherein said rotation of said platform causes a centripetal force applied to said user, such that blood of said user flows from said axis to at least one extremity of said user.

3. The apparatus of claim 2, wherein said flow of said blood assists in overcoming symptoms of reflux sympathetic dystrophy (RSD) and neuropathy.

4. The apparatus of claim 1, wherein said platform is a chair.

5. The apparatus of claim 1, wherein said mount comprises a wheel that moves along said top surface of said base when said drive mechanism rotates said mount.

6. The apparatus of claim 1, wherein said drive mechanism is an electric motor.

7. The apparatus of claim 1 further comprising an arm extending from said base.

8. The apparatus of claim 7 further comprising a controller on said arm, wherein said arm extends from said base, such that said controller is accessible by said user when said drive mechanisms is rotating said mount and platform.

9. The apparatus of claim 1, wherein said drive mechanism rotates said mount and platform at a range of approximately 5 to 120 revolutions per minute (rpms).

10. An apparatus comprising:
a base comprising a top surface;
a mount moveably connected to said top surface of said base;
an electric motor adjacent to said top surface said base, and rotatably connected to said mount, such that said mount moves along said top surface of said base; and
a chair configured to receive a user of the apparatus, said chair connected to said mount and rotatably connected to said electric motor, wherein said chair rotates with respect to said base at an axis that extends through a neck region of said user and at a rotational speed sufficient to cause blood of said user to flow from said axis to at least one extremity of said user.

11. The apparatus of claim 10, wherein said flow of said blood assists in overcoming symptoms of reflux sympathetic dystrophy (RSD) and neuropathy.

12. The apparatus of claim 10, wherein said mount comprises a wheel that moves along said top surface of said base when said drive mechanism rotates said mount.

13. The apparatus of claim 10 further comprising an arm extending from said base.

14. The apparatus of claim 13 further comprising a controller on said arm, wherein said arm extends from said base, such that said controller is accessible by said user when said drive mechanisms is rotating said mount and platform.

15. A method of treating poor circulation resulting from vascular disease in a patient in need thereof which comprises:
providing a rotary apparatus for use by the patient;
controlling a rotational speed of the rotary apparatus;
providing a therapeutically effective amount of a centripetal force to the patient for a sufficient period of time;
promoting blood flow to at least one extremity of the patient.
